(19) United States
(12) Patent Application Publication
(10) Pub. No.: US 2024/0289563 A1
(43) Pub. Date: Aug. 29, 2024

(54) SPEECH-TO-SPEECH TRANSLATION WITH MONOLINGUAL DATA

(71) Applicant: GOOGLE LLC, Mountain View, CA (US)

(72) Inventors: Michelle Tadmor Ramanovich, Tel-Aviv (IL); Eliya Nachmani, Tel-Aviv (IL); Alon Levkovitch, Tel-Aviv (IL); Byungha Chun, Tokyo (JP); Yifan Ding, Tokyo (JP); Nadav Bar, Raanana (IL); Chulayuth Asawaroengchai, Zurich (CH)

(21) Appl. No.: 18/589,358

(22) Filed: Feb. 27, 2024

Related U.S. Application Data
(60) Provisional application No. 63/448,983, filed on Feb. 28, 2023.

(51) Int. Cl. G06F 40/58; G10L 15/00; G10L 15/06; G10L 25/18

(52) U.S. Cl. CPC G06F 40/58; G10L 15/005; G10L 15/063; G10L 25/18; G10L 2015/0635

(57) ABSTRACT

Training and/or utilizing a Speech-To-Speech Translation (S2ST) system that can be used to generate, based on processing source audio data that captures a spoken utterance in a source language, target audio data that includes a synthetic spoken utterance that is spoken in a target language and that corresponds, both linguistically and para-linguistically, to the spoken utterance in the source language. Implementations that are directed to training the S2ST system utilize an unsupervised approach, with monolingual speech data, in training the S2ST system.

### BACKGROUND

Conventional Speech-To-Speech Translation (S2ST) systems are implemented as a cascade of three separate components: an automatic speech recognition (ASR) component for generating source language text from a spoken utterance in a source language, a machine translation (MT) component for converting the source language text to target language text in a target language, and a text-to-speech (TTS) synthesis component for generating synthesized speech that corresponds to the target language text.

End-to-end direct S2ST systems, such as those that utilize a single sequence-to-sequence model, have been proposed that dismiss with the cascade of three separate components of conventional S2ST systems. Rather, they instead sequentially process, as input, audio data corresponding to a source language spoken utterance and sequentially generate, as output based on the processing, audio data that corresponds to synthesized speech that is in the target language and that corresponds linguistically to the source language spoken utterance.

Some direct S2ST systems have also demonstrated the ability to preserve and translate, at least selectively and at least some para-linguistic speech characteristics of a human speaker of a source utterance. Para-linguistic speech characteristics include, for example, speaking style, emotion, emphasis, phonation, and/or vocal burst. Such para-linguistic characteristics are essential aspects of human verbal communication, ensuring that a human user that is the recipient of speech can fully and readily comprehend the speech—as such para-linguistic characteristics can impact the ability to comprehend the speech and/or can impact the underlying meaning of speech. However, para-linguistic speech characteristics are often lost in conventional cascaded S2ST systems.

Moreover, even with direct S2ST systems, preservation of para-linguistic features can be absent or limited. This can be due to a lack of, or limited quantity of, supervised data, that is truly para-linguistic bilingual data, on which to train such direct S2ST systems. Supervised truly para-linguistic bilingual data includes target speech instances with the same para-linguistic characteristics as the source speech. Direct S2ST systems are often trained utilizing target speech instances that are (a) synthesized speech instances that fail to preserve para-linguistic characteristics of corresponding source speech instances and/or (b) human speech instances that fail to have para-linguistic characteristics that align with corresponding source speech instances. As a result, training direct S2ST systems based on such target speech instances results in preservation of para-linguistic features being absent or limited.

### SUMMARY

Implementations disclosed herein are directed to training and/or utilizing a direct S2ST system, where the direct S2ST system can be used to generate, based on processing source audio data that captures a spoken utterance in a source language, target audio data that includes a synthetic spoken utterance that is spoken in a target language and that corresponds, both linguistically and para-linguistically, to the spoken utterance in the source language.

Implementations that are directed to training the S2ST system utilize an unsupervised approach, with monolingual speech data, in training the S2ST system. The unsupervised training approach of implementations disclosed herein enables the S2ST system to, once trained, be used in processing source audio data that captures a source language spoken utterance to generate target audio data, that includes a synthetic spoken utterance that is spoken in a target language, that not only corresponds linguistically to the source language spoken utterance but that also corresponds para-linguistically to the source language spoken utterance. This para-linguistic correspondence can ensure that a target user, who speaks the target language and is listening to rendering of the target audio data that includes the target language synthetic spoken utterance, can fully and readily comprehend the target language synthetic spoken utterance—and that such comprehension conforms to the intent of the source language spoken utterance.

Moreover, utilization of the unsupervised approach, with monolingual speech data, according to implementations disclosed herein, can eliminate (or at least lessen) the need for bilingual speech data, such as supervised truly para-linguistic bilingual data. Truly para-linguistic bilingual data can be burdensome (e.g., computationally burdensome) to generate, requiring computational resource utilization in recording and labeling of bilingual pairs. Monolingual speech data can be more efficient to generate and/or already readily available, and training of a S2ST system according to implementations disclosed herein can be based on an unsupervised approach, with such monolingual speech data. For example, the unsupervised approach, with monolingual speech data can be used exclusively or can be a majority (e.g., more than 50%, more than 80%, more than 90%) of the training utilized in training a S2ST system.

In some implementations, the S2ST system includes an end-to-end model that includes a shared encoder and at least two decoders, where each of the at least two decoders corresponds to a different language. Each decoder can include a linguistic decoder, an acoustic synthesizer, and a singular attention module. The shared encoder can be used to encode audio data (e.g., a spectrogram of) that captures a spoke utterance that is in any of the languages of the at least two decoders. Through training, the encoder is able to learn a multilingual embedding space across any of the languages of the at least two decoders.

In some implementations, training the S2ST system can include at least two phases: (i) an auto-encoding, reconstruction phase and (ii) a back-translation phase. In the (i) auto-encoding, reconstruction phase, the S2ST system (e.g., the shared encoder and the decoders) is trained to auto-encode inputs to a multilingual embedding space using a multilingual unsupervised embedding (MUSE) loss and a reconstruction loss. The (i) auto-encoding phase aims to ensure that the S2ST system (e.g., the shared encoder) generates meaningful multi-lingual representations. In the (ii) back-translation phase, the S2ST system is further trained to translate the input spectrogram by utilizing a back-translation loss. Optionally, to mitigate the issue of catastrophic forgetting and/or to enforce the latent space to be multilingual, the MUSE loss can also be applied in the (ii) back-translation phase.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A depicts an example multilingual encoder, an example first language decoder, and example processing that can occur in training the multilingual encoder and the first language decoder using monolingual data and in an auto-encoding, reconstruction training phase.

FIG. 2B depicts the example multilingual encoder and an example second language decoder, and example processing that can occur in training the multilingual encoder and the second language decoder using monolingual data and in an auto-encoding, reconstruction training phase.

FIG. 2C depicts the example multilingual encoder, the example first language decoder, and the example second language decoder, and example processing that can occur in training the multilingual encoder and the first and second language decoders using monolingual data and in a back-translation training phase.

FIG. 3 depicts a flowchart illustrating an example method of training a multilingual encoder and decoders using monolingual data and in an auto-encoding, reconstruction training phase.

FIG. 4 depicts a flowchart illustrating an example method of training a multilingual encoder and decoders using monolingual data and in a back-translation training phase.

FIG. 5 depicts a flowchart illustrating an example method of utilizing a trained multilingual encoder and one of a plurality of trained decoders.

FIG. 6 depicts an example architecture of a computing device, in accordance with various implementations.

### DETAILED DESCRIPTION

Prior to turning to the figures, non-limiting examples of some implementations disclosed herein are provided. Aspects of those non-limiting examples reference a source language and a target language. However, it is noted that implementations disclosed herein can be utilized to train an S2ST system that can be used to translate to any of multiple disparate target languages and/or to translate from any of multiple disparate source languages. For example, implementations can be utilized to train an S2ST system that can be used to translate from a source language to a first target language (e.g., via a first language decoder), a second target language (e.g., via a second language decoder), and/or a third target language (e.g., via a third language decoder). As another example, implementations can be utilized to train an S2ST system that can be used to translate from any one or multiple source languages via the multilingual encoder (e.g., when trained based on the multiple source languages).

In some implementations, an unsupervised approach to training an end-to-end model for S2ST is provided. The end-to-end model can include a shared encoder and at least two decoders, where each of the decoders is for a different language. The model can be trained using a combination of an unsupervised MUSE embedding loss, a reconstruction loss, and an S2ST back-translation loss. During inference, the shared encoder can be used to encode input (e.g., a spectrogram of audio data capturing a spoken utterance in a first language) into a multilingual embedding space, which is subsequently decoded by a target decoder that is for a second language that is the target language.

As referenced above, a shared encoder E can be used to encode multiple languages, such as a source language and a target language. A decoder D for a given one of the multiple languages can include a linguistic decoder, an acoustic synthesizer, and a singular attention module. There are at least two decoders, such as one for the source language Dₛ and another for the target language Dₜ.

The output of the encoder E(Sⁱⁿ) is split into two parts, E(Sⁱⁿ)=[Eₘ(Sⁱⁿ), Eₒ(Sⁱⁿ)], where Sⁱⁿ can be the source or target language. The first half of the output Eₘ(Sⁱⁿ) is trained to be the MUSE embeddings of the text of the input spectrogram Sⁱⁿ. This is forced using the MUSE loss. The latter half Eₒ(Sⁱⁿ) is updated without the MUSE loss. It is important to note that the same encoder E is shared between multiple languages, such as source and target languages. Furthermore, the MUSE embeddings are multilingual in nature. As a result, the encoder is able to learn a multilingual embedding space across source and target languages.

The decoder D can be composed of three distinct components, namely the linguistic decoder, the acoustic synthesizer, and the attention module. To effectively handle the different properties of the source and target languages, it has two separate decoders, D^{s} and D^{t}, for the source and target languages, respectively. The decoder output can be formulated as S^{out}=D^{out}(E(Sⁱⁿ)), where Sⁱⁿ and S^{out} correspond to the input and output sequences. Both Sⁱⁿ and S^{out} may represent either the source or target language, as well as D^{out}.

Implementations of the training methodology disclosed herein include at least two phases: (i) an auto-encoding, reconstruction phase and (ii) a back-translation phase. In the first phase, the model is trained to auto-encode the input to a multilingual embedding space using the MUSE loss and the reconstruction loss. This first phase aims to ensure that the model generates meaningful multilingual representations. In the second phase, the model is further trained to translate the input spectrogram by utilizing the back-translation loss. To mitigate the issue of catastrophic forgetting and/or to enforce the latent space to be multilingual, the MUSE loss and the reconstruction loss are also optionally applied in the second phase of the training. To ensure that the encoder learns meaningful properties of the input, rather than simply reconstructing the input, SpecAugment and/or other augmentation or noising techniques can optionally be utilized to modify spectrograms and/or audio data prior to processing of the spectrograms by the multilingual decoder during training. The first phase can optionally be viewed as masked auto-encoder training.

As referenced above, to ensure that the encoder E generates multi-lingual representations that are meaningful for all decoders (e.g., decoders D^{s} and D^{t}), a MUSE loss can be utilized during training. The MUSE loss forces the encoder to generate such a meaningful multi-lingual representation by using pre-trained MUSE embeddings. These pre-trained MUSE embeddings are computed in an unsupervised manner. During the training process, given an input transcript with n words, n corresponding MUSE embeddings E∈R^{n×d} can be extracted from the embeddings of the input language. The error between E and the n first output vectors of the encoder E is then minimized. This can be represented as

$${ℒ}_{MUSE} ( {S}^{in} ) = \frac{1}{n} {\sum }_{i = 1}^{n} {‖ ε ( {S}^{in} ) i - {E}_{i} ‖}_{2}^{2} ,$$

where Sⁱⁿ represents the input spectrogram, which may be in the source or target language, and Eᵢ is the d-dimensional embedding vector for i-th word. Note that the encoder E is indifferent to the language of the input during inference due to multilingual embeddings.

In the auto-encoding, reconstruction phase, the model learns to auto-encode both the source and target languages. The reconstruction loss can be computed as a linear combination of three losses for both the source and target languages. The main reconstruction objective can be L_{spec}, where with a given a paired example {S^{t′},S^{t}}, the loss function can be expressed as

$${ℒ}_{spec} ( {S}^{{t}^{′}} , {S}^{t} ) = \frac{1}{TK} {\sum }_{i = 1}^{T} {\sum }_{j = 1}^{2} {‖ {S}_{i}^{{t}^{′}} - {S}_{i}^{t} ‖}_{j}^{j} \qquad ( 1 )$$

where Sᵢ^{t} denotes the i-th frame of Sⁱ, T is the number of frames in S^{t}, K is the number of frequency bins in Sᵢ^{t}, and ∥ⱼ^{j} denotes the Lⱼ distance. An optionally additional loss can be a duration loss between total number of frames T and the sum of phoneme durations predicted in the acoustic synthesizer. It is given as [symbol] _{dur}=(T−Σᵢ₌₁^{p}dᵢ)², where dᵢ is the predicted duration for the i-th phoneme. A further optional additional loss can be an auxiliary phoneme loss. Let

$${\tilde{P}}^{t} = \{ {\tilde{P}}_{1}^{t} , … , {\tilde{P}}_{p}^{t} \}$$

be the sequence of predicted probabilities over target phonemes,

$${P}^{t} = \{ \overline{{P}_{1}^{t} , … , \overline{{P}_{p}^{t}}} \}$$

be the ground-truth target phoneme sequence, and CE(⋅, ⋅) be the cross entropy. Then the phoneme loss (Lₚₕₙ) can be represented as

$${ℒ}_{phn} ( , {P}^{t} ) = \frac{1}{P} {\sum }_{i = 1}^{p} CE ( {\tilde{P}}_{i}^{t} , {P}_{i}^{t} ) . \qquad ( 2 )$$

The overall reconstruction loss (L_{recon}) can be summarized as

$${L}_{recon} = {L}_{spec}^{src} ( {S}^{{s}^{′}} , {S}^{s} ) + {L}_{dur}^{src} + {L}_{phn}^{src} ( , {P}^{s} ) + {L}_{spec}^{tgt} ( {S}^{{t}^{′}} , {S}^{t} ) + {L}_{dur}^{tgt} + {L}_{phn}^{tgt} ( , {P}^{t} ) , \qquad ( 3 )$$

where S^{s} and S^{t} are the source and target spectrograms respectively, S^{s′} and S^{t′} represent the model spectrogram output predictions, [symbol] and [symbol] represent the probability distributions of the phonemes of the source and target languages respectively, and P^{s} and P^{t} represent the phoneme sequences of the source and target text respectively.

In the back-translation training phase, the process begins with the encoding of a source input spectrogram, represented as E(S^{s}), followed by the use of a target language decoder to produce a pseudo-translation, denoted as [symbol] as S^{t′}=D^{t}(E(S^{s})). Subsequently, the pseudo-translation is encoded utilizing the encoder E( [symbol] ). The final step in this process involves decoding the encoded pseudo-translation using the decoder of the source language [symbol] =D^{s}(E( [symbol] )). Lastly, a loss function is applied to minimize the dissimilarity to the input spectrogram:

$${L}_{back - translation}^{src 2 tgt} = {L}_{spec}^{src} ( , {S}^{s} ) + {L}_{dur}^{src} + {L}_{phn}^{src} ( , {P}^{s} ) . \qquad ( 4 )$$

In the back-translation training phase, the aforementioned process can also be applied in the reverse direction, from the target to the source language. This process entails utilizing the same methodologies and techniques as previously described, with the only difference being the direction of the translation:

$${L}_{back - translation}^{tgt 2 src} = {L}_{spec}^{tgt} ( , {S}^{t} ) + {L}_{dur}^{tgt} + {L}_{phn}^{tgt} ( , {P}^{t} ) . \qquad ( 5 )$$

The overall back-translation loss can be represented as:

$${L}_{back - translation} = {L}_{back - translation}^{src 2 tgt} + {L}_{back - translation}^{tgt 2 src} . \qquad ( 6 )$$

For the auto-encoding, reconstruction phase, the loss can be represented by:

$${L}_{recon - phase} = {L}_{recon} + {L}_{MUSE} ( {S}^{s} ) + {L}_{MUSE} ( {S}^{t} ) \qquad ( 7 )$$

In the back-translation phase, the optimization of both the back-translation loss (L_{back-translation}), and the reconstruction loss (L_{recon-phase}), is carried out to ensure that the encoder output produces a multilingual embedding. The overall loss is:

$${L}_{BT - phase} = {L}_{back - translation} + {L}_{recon - phase} . \qquad ( 8 )$$

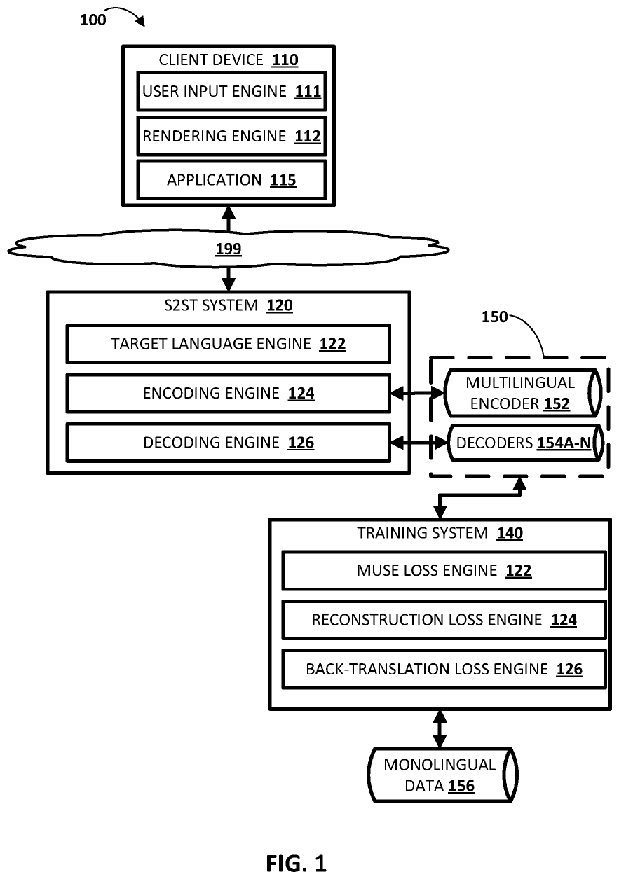

Turning now to FIG. 1, a block diagram of an example environment 100 that demonstrates various aspects of the present disclosure, and in which implementations disclosed herein can be implemented, is depicted. The example environment 100 includes a client device 110, a S2ST system 120, a training system 140. The example environment 100 further includes a monolingual data database 156 that is utilized by the training system 140 in training an end-to-end S2ST model 150. The end-to-end S2ST model 150 is a neural network model (e.g., a sequence-to-sequence neural network model), is utilized by the S2ST system 120, and includes a multilingual encoder 152 and a plurality of decoders 154A-N. Each of the decoders 154A-N is trained for use with a respective spoken language that is distinct relative to all other spoken languages for which the other decoder(s) are trained.

Although illustrated separately, in some implementations all or aspects of S2ST system 120 and/or training system 140 can be implemented as part of a cohesive system. For example, the same entity can be in control of the S2ST system 120 and the training system 140, and implement them cohesively. However, in some implementations one or more of the system(s) can be controlled by separate parties. In some of those implementations, one party can interface with system(s) of another party utilizing, for example, application programming interface(s) (APIs) of such system(s).

In some implementations, all or aspects of the S2ST system 120 can be implemented locally at the client device 110. In additional or alternative implementations, all or aspects of the S2ST system 120 can be implemented remotely from the client device 110 as depicted in FIG. 1 (e.g., at remote server(s)). In those implementations, the client device 110 and the S2ST system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., headphones, earbuds, a watch of the user having a computing device, glasses of the user having a computing device, a virtual or augmented reality computing device). Additional and/or alternative client devices may be provided.

The client device 110 can execute one or more applications, such as application 115, via which audio data that captures a spoken utterance in a given language can be detected and/or via which audio data, that includes a synthetic spoken utterance in an additional language but that corresponds linguistically and para-linguistically to the spoken utterance, can be rendered. For example, audio data (or a spectrogram thereof) that captures the spoken utterance can be provided, by the application 115, to the S2ST system 120. The S2ST system 120 can process the audio data (e.g., a spectrogram thereof) using the multilingual encoder 152 and a decoder, of the decoders 154A-N, that corresponds to the additional language, to generate an additional language spectrogram. The audio data, that includes a synthetic spoken utterance in the additional language and that corresponds linguistically and para-linguistically to the spoken utterance, can be based on the generated additional language spectrogram. Optionally, the S2ST system 120 can be part of the application 115.

Although only a single client device 110 is illustrated in FIG. 1 for simplicity, it is understood that in some implementations audio data that captures a spoken utterance in a given language can be detected at a first client device and audio data, that includes a synthetic spoken utterance in an additional language and that corresponds linguistically and para-linguistically to the spoken utterance, can be rendered at a distinct second client device 110. For example, the first and second client devices can be of first and second users that speak disparate languages and can be geographically remote but coupled (e.g., indirectly) via network(s) 199, enabling the first and second users to converse with one another. For example, the first and second client devices can be communicatively coupled in a communications session with one another.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110, such as touch input that selects a target language to which spoken utterances are to be translated.

In various implementations, the client device 110 can include a rendering engine 112 that is configured to provide content for audible and/or visual presentation to a user of the client device 110 using one or more user interface output devices. For example, the client device 110 can be equipped with one or more speakers that enable audio content to be provided for audible presentation to the user via the client device 110, such as audio data that includes a synthetic spoken utterance that is in a given language and that corresponds, linguistically and para-linguistically, to a spoken utterance in an additional language—and that is generated based on audio data that captures the spoken utterance in the additional language. Additionally, or alternatively, the client device 110 can be equipped with a display or projector that enables content to be provided for visual presentation to the user via the client device 110.

The training system 140 interacts with the S2ST system 120 and utilizes the instances of monolingual data, from monolingual data database 156, to train the end-to-end S2ST model 150. In some implementations, the training system 140 can perform one or more of the steps of method 300 and/or method 400 in training the end-to-end S2ST model 150. In some implementations, the training system 140 can train the end-to-end S2ST model 150 in at least two phases: (i) an auto-encoding, reconstruction phase and (ii) a back-translation phase. In the (i) auto-encoding phase, the training system 140 can train the end-to-end S2ST model 150 to auto-encode inputs to a multilingual embedding space, and can train the end-to-end S2ST model 150 using a MUSE loss and a reconstruction loss. In the (ii) back-translation phase, the training system can train the end-to-end S2ST model 150 to the input spectrogram by utilizing a back-translation loss. Optionally, and to mitigate the issue of catastrophic forgetting and/or to enforce the latent space to be multilingual, the training system 140 can also utilize the MUSE loss in the (ii) back-translation phase.

The training system 140 can include a MUSE loss engine 122 for generating the MUSE losses. For example, in generating a MUSE loss the MUSE loss engine 122 can generate the MUSE loss based on a multilingual embedding generated based on audio data that captures a spoken utterance in a given language and based on N corresponding MUSE embeddings. The N corresponding MUSE embeddings can each be for a corresponding word (or other token) of a transcript of the spoken utterance, and can be pre-trained MUSE embeddings and can be selected based on the transcript of the spoken utterance. For example, the spoken utterance can be one from monolingual data database 156, and can have the transcript assigned to it in the monolingual data database 156.

The training system 140 can also include a reconstruction loss engine 124 for generating the reconstruction losses. In some implementations, in generating a reconstruction loss the reconstruction loss engine 124 can generate the reconstruction loss based on comparing features of a given language spectrogram processed using the multilingual encoder to generate a multilingual embedding, and a predicted given language spectrogram generated based on processing the multilingual embedding using a decoder for the given language. In some of those implementations, the reconstruction loss can be based on (e.g., a linear sum of) a spectrogram loss, a phoneme loss, and/or a duration loss. The spectrogram loss can be based on a distance between the given language spectrogram and the predicted given language spectrogram. The phoneme loss can be generated based on a cross entropy of predicted probabilities over phonemes, predicted by the decoder for the given language (e.g., by a linguistic decoder thereof) and a ground truth target phoneme sequence for the given language spectrogram. The duration loss can be generated based on a difference between the total quantity of frames in the given language spectrogram and the total quantity of frames in the predicted given language spectrogram.

The training system 140 can also include a back-translation loss engine 126 for generating the back-translation reconstruction losses. In some implementations, in generating a back-translation reconstruction loss, the back-translation loss engine 126 can generate the back-translation reconstruction loss based on comparing features of a given language spectrogram processed using the multilingual encoder to generate a multilingual embedding, and a predicted back-translation given language spectrogram. The predicted back-translation given language spectrogram is generated based on (i) processing the multilingual embedding using a decoder for the target language to generate a predicted target language spectrogram, (ii) processing the predicted target language spectrogram using the multilingual encoder to generate an additional multilingual embedding, and (iii) processing the additional multilingual embedding using a decoder for the given language to generate the predicted back-translation given language spectrogram. In some of those implementations, the reconstruction loss can be based on (e.g., a linear sum of) a spectrogram loss, a phoneme loss, and/or a duration loss. The spectrogram loss can be based on a distance between the given language spectrogram and the predicted back-translation given language spectrogram. The phoneme loss can be generated based on a cross entropy of predicted probabilities over phonemes, predicted by the decoder for the given language (e.g., by a linguistic decoder thereof) in generating the predicted back-translation given language spectrogram and a ground truth target phoneme sequence for the given language spectrogram. The duration loss can be generated based on a difference between the total quantity of frames in the given language spectrogram and the total quantity of frames in the predicted back-translation given language spectrogram.

Inference system 120 is illustrated as including a target language engine 122, an encoding engine 124, and a decoding engine 126.

The target language engine 122 can identify a target language to which source audio data is to be automatically translated and can select, based on the identified target language and from a plurality of decoders each trained for a different corresponding language, a target language decoder to utilize in an instance of S2ST. In some implementations, the target language engine 122 can identify the target language based on it being specified in user interface input provided at an input device of a corresponding client device. For example, the target language can be specified in touch input (e.g., selected from a list of candidate target languages) or specified in spoken input. In some other implementations, the target language engine 122 can identify the target language automatically and independently of any user interface input. For example, the target language can be identified based on a detected location of a corresponding client device, detection of the target language in ambient audio data, and/or utilizing other technique(s).

The encoding engine 124 can process audio data (e.g., a spectrogram thereof), that captures a spoken utterance in a first language, using the multilingual encoder to generate a multilingual embedding.

The decoding engine 126 can process the multilingual embedding, using a selected one of the decoders for a second language, to generate target audio data (e.g., a spectrogram thereof) that includes a synthetic spoken utterance that is spoken in the second language and that corresponds, both linguistically and para-linguistically, to the spoken utterance in the first language. The S2ST system 120 can cause the target audio data to be rendered at the client device 110 or another client device. For example, when the S2ST system 120 is remote from the client device 110, it can transmit the audio data to the client device 110 over network(s) 199 and the application 115 of the client device can render the audio data based on receiving it in the transmission.

Further, the client device 110, the S2ST system 120, and/or the training system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the network(s) 199.

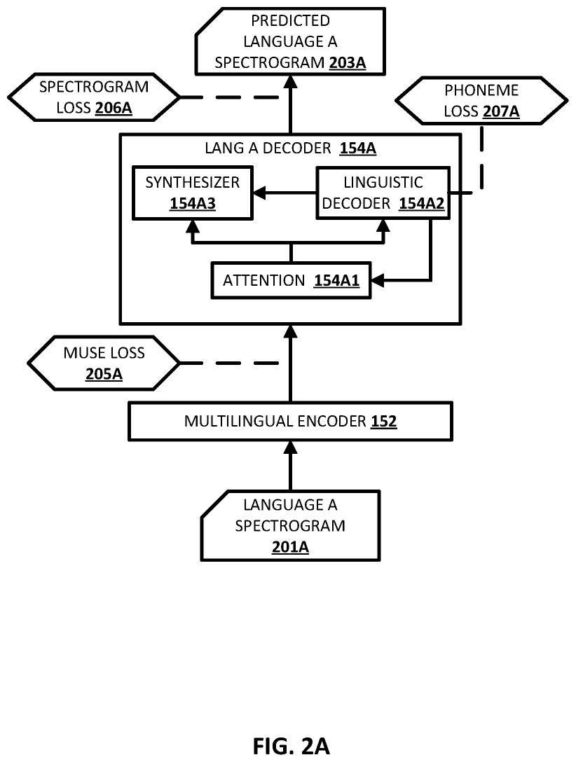

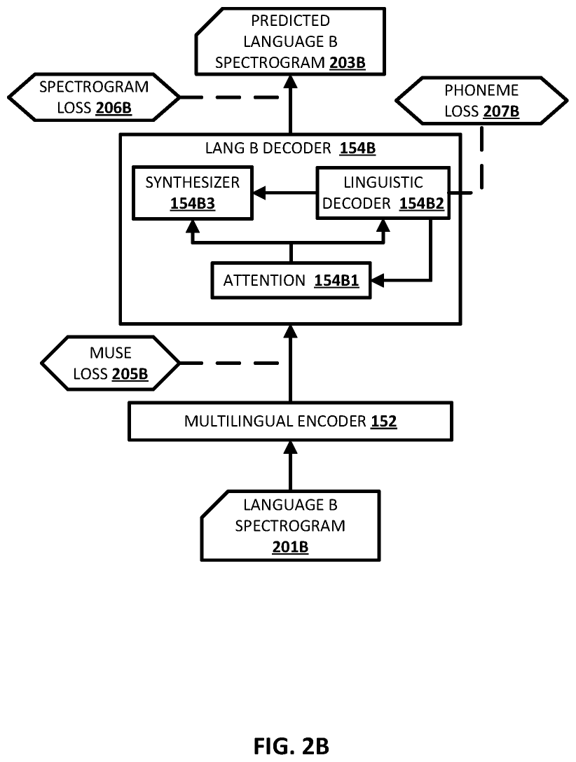

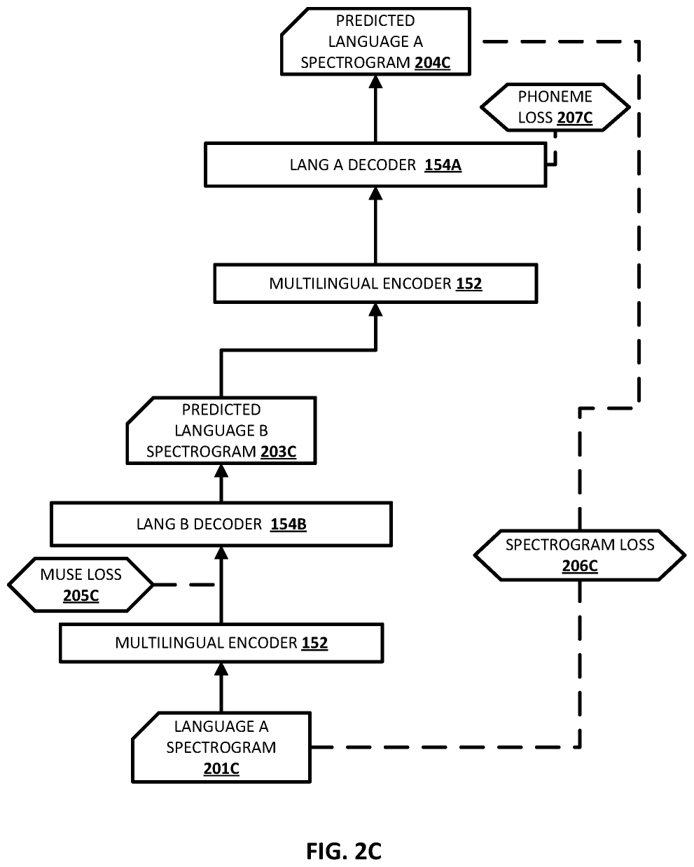

FIG. 2A depicts an example multilingual encoder 152, an example first language decoder 154A, and example processing that can occur in training the multilingual encoder 152 and the first language decoder 154A using monolingual data and in an auto-encoding, reconstruction training phase. In FIG. 2A, the example first language decoder 154A is for a first language “A”, includes an attention module 154A1, a linguistic decoder 154A2, and an acoustic synthesizer 154A3.

In FIG. 2A, a language A spectrogram 201A, that corresponds to audio data capturing a spoken utterance in the first language of the first language decoder 154A, is processed using the multilingual encoder 152 to generate a multilingual embedding (not illustrated) that is provided to the first language decoder 154A. Optionally, and as described herring, noise or other augmentations can be applied to the language A spectrogram 201A prior to processing using the multilingual encoder 152. The multilingual embedding is processed, using the first language decoder 154A (e.g., the attention module 154A1, linguistic decoder 154A2, and acoustic synthesizer 154A3 thereof) to generate a predicted language A spectrogram 203A. The predicted language A spectrogram 203A is a predicted reconstruction of the language A spectrogram 201A and is also in the first language of the language A spectrogram 201A.

As illustrated in FIG. 2A, a MUSE loss 205A can be generated (e.g., by training system 140 of FIG. 1) based on the multilingual embedding generated using the multilingual encoder 152 in processing the language A spectrogram 201A. The MUSE loss 205A can be used (e.g., by training system 140 of FIG. 1) in updating the multilingual encoder 152 and, optionally, the first language decoder 154A. For example, the MUSE loss 205A can be backpropagated, optionally along with other loss(es) for the training instance of FIG. 2A and/or for other training instance(s), in updating the multilingual encoder 152 and, optionally, the first language decoder 154A.

Further, a spectrogram loss 206A and a phoneme loss 207A are also illustrated in FIG. 2A. The spectrogram loss 206A and the phoneme loss 207A can form part of a reconstruction loss, optionally along with a duration loss (not illustrated in FIG. 2A). The spectrogram loss 206A can be generated (e.g., by training system 140 of FIG. 1) based on a distance between the language A spectrogram 201A and the predicted language A spectrogram 203A. The phoneme loss 207A can be generated (e.g., by training system 140 of FIG. 1) based on a cross entropy of predicted probabilities over phonemes, predicted by the linguistic decoder 154A2 in generating the predicted language A spectrogram 203A, and a ground truth target phoneme sequence for the language A spectrogram 201A. The spectrogram loss 206A and the phoneme loss 207A can be used (e.g., by training system 140 of FIG. 1) in updating the first language decoder 154A and, optionally, the multilingual encoder 152. For example, the spectrogram loss 206A and the phoneme loss 207A can be combined to generate a reconstruction loss, and the reconstruction loss backpropagated, optionally along with other loss(es) for the training instance of FIG. 2A and/or for other training instance(s), in updating the first language decoder 154A and, optionally, the multilingual encoder 152.

FIG. 2B depicts the example multilingual encoder 152 and an example second language decoder 154B, and example processing that can occur in training the multilingual encoder 152 and the second language decoder 154B using monolingual data and in an auto-encoding, reconstruction training phase. In FIG. 2B, the example second language decoder 154B is for a second language “B”, includes an attention module 154B1, a linguistic decoder 154B2, and an acoustic synthesizer 154B3.

In FIG. 2B, a language B spectrogram 201B, that corresponds to audio data capturing a spoken utterance in the second language of the second language decoder 154B, is processed using the multilingual encoder 152 to generate a multilingual embedding (not illustrated) that is provided to the second language decoder 154B. Optionally, and as described herring, noise or other augmentations can be applied to the language B spectrogram 201B prior to processing using the multilingual encoder 152. The multilingual embedding is processed, using the second language decoder 154B (e.g., the attention module 154B1, linguistic decoder 154B2, and acoustic synthesizer 154B3 thereof) to generate a predicted language B spectrogram 203A. The predicted language B spectrogram 203B is a predicted reconstruction of the language B spectrogram 201B and is also in the second language of the language B spectrogram 201B.

As illustrated in FIG. 2B, a MUSE loss 205B can be generated (e.g., by training system 140 of FIG. 1) based on the multilingual embedding generated using the multilingual encoder 152 in processing the language B spectrogram 201B. The MUSE loss 205B can be used (e.g., by training system 140 of FIG. 1) in updating the multilingual encoder 152 and, optionally, the second language decoder 154B. For example, the MUSE loss 205B can be backpropagated, optionally along with other loss(es) for the training instance of FIG. 2B and/or for other training instance(s), in updating the multilingual encoder 152 and, optionally, the second language decoder 154B.

Further, a spectrogram loss 206B and a phoneme loss 207B are also illustrated in FIG. 2B. The spectrogram loss 206B and the phoneme loss 207B can form part of a reconstruction loss, optionally along with a duration loss (not illustrated in FIG. 2B). The spectrogram loss 206B can be generated (e.g., by training system 140 of FIG. 1) based on a distance between the language B spectrogram 201B and the predicted language B spectrogram 203B. The phoneme loss 207B can be generated (e.g., by training system 140 of FIG. 1) based on a cross entropy of predicted probabilities over phonemes, predicted by the linguistic decoder 154B2 in generating the predicted language B spectrogram 203B, and a ground truth target phoneme sequence for the language B spectrogram 201B. The spectrogram loss 206B and the phoneme loss 207B can be used (e.g., by training system 140 of FIG. 1) in updating the second language decoder 154B and, optionally, the multilingual encoder 152. For example, the spectrogram loss 206B and the phoneme loss 207B can be combined to generate a reconstruction loss, and the reconstruction loss backpropagated, optionally along with other loss(es) for the training instance of FIG. 2B and/or for other training instance(s), in updating the second language decoder 154B and, optionally, the multilingual encoder 152.

FIG. 2C depicts the example multilingual encoder 152, the example first language decoder 154A, and the example second language decoder 154B, and example processing that can occur in training the multilingual encoder and the first and second language decoders using monolingual data and in a back-translation training phase.

In FIG. 2C, a language A spectrogram 201C, that corresponds to audio data capturing a spoken utterance in the first language of the first language decoder 154A, is processed using the multilingual encoder 152 to generate a multilingual embedding (not illustrated) that is provided to the second language decoder 154B. Optionally, and as described herring, noise or other augmentations can be applied to the language A spectrogram 201C prior to processing using the multilingual encoder 152. The multilingual embedding is processed, using the second language decoder 154B to generate a predicted language B spectrogram 203C. The predicted language B spectrogram 203C is a predicted spectrogram that is in the second language of the second language decoder 154B but attempts to correspond linguistically and para-linguistically to the language A spectrogram 201C.

The predicted language B spectrogram 203C is then processed using the multilingual encoder 152 to generate an additional multilingual embedding (not illustrated) that is provided to the first language decoder 154A. The additional multilingual embedding is processed, using the first language decoder 154A to generate a predicted language A spectrogram 204C. The predicted language A spectrogram 204C is a predicted spectrogram that is in the first language of the first language decoder 154A and is generated based on a S2ST of predicted language B spectrogram, which itself is generated based on a S2ST of language A spectrogram 201C.

As illustrated in FIG. 2C, a MUSE loss 205C can be generated (e.g., by training system 140 of FIG. 1) based on the multilingual embedding generated using the multilingual encoder 152 in processing the language A spectrogram 201C. The MUSE loss 205C can be used (e.g., by training system 140 of FIG. 1) in updating the multilingual encoder 152 and, optionally, the first language decoder 154A and/or the second language decoder 154B. For example, the MUSE loss 205C can be backpropagated, optionally along with other loss(es) for the training instance of FIG. 2C and/or for other training instance(s), in updating the multilingual encoder 152 and, optionally, the first language decoder 154A and/or the second language decoder 154B.

Further, a spectrogram loss 206C and a phoneme loss 207C are also illustrated in FIG. 2C. The spectrogram loss 206C and the phoneme loss 207C can form part of a back-translation reconstruction loss, optionally along with a duration loss (not illustrated in FIG. 2C). The spectrogram loss 206C can be generated (e.g., by training system 140 of FIG. 1) based on a distance between the language A spectrogram 201C and the predicted language A spectrogram 203A. The phoneme loss 207B can be generated (e.g., by training system 140 of FIG. 1) based on a cross entropy of predicted probabilities over phonemes, predicted by the linguistic decoder 154A2, of first language decoder 154A, in generating the predicted language A spectrogram 203C, and a ground truth target phoneme sequence for the language A spectrogram 201C. The spectrogram loss 206C and the phoneme loss 207C can be used (e.g., by training system 140 of FIG. 1) in updating the first language decoder 154A and, optionally, the second language decoder 154B and/or the multilingual encoder 152. For example, the spectrogram loss 206C and the phoneme loss 207C can be combined to generate a reconstruction loss, and the reconstruction loss backpropagated, optionally along with other loss(es) for the training instance of FIG. 2C and/or for other training instance(s), in updating the first language decoder 154A and, optionally, the second language decoder 154B and/or the multilingual encoder 152.

It is noted that in various implementations, the back-translation training phase can also include starting with a language B spectrogram; generating a predicted language A spectrogram based on processing the language B spectrogram using the multilingual encoder 152 to generate a multilingual embedding and processing the multilingual embedding using the first language decoder 154A; and then generating a predicted language B spectrogram based on processing the predicted language A spectrogram using the multilingual encoder 152 to generate an additional multilingual embedding and processing the additional multilingual embedding using the second language decoder 154B. Accordingly, in such a scenario the predicted language B spectrogram is a predicted spectrogram that is in the second language of the second language decoder 154B and is generated based on a S2ST of predicted language A spectrogram, which itself is generated based on a S2ST of a language B spectrogram. Further, in such a scenario, MUSE and back-translation losses can be similarly generated and utilized.

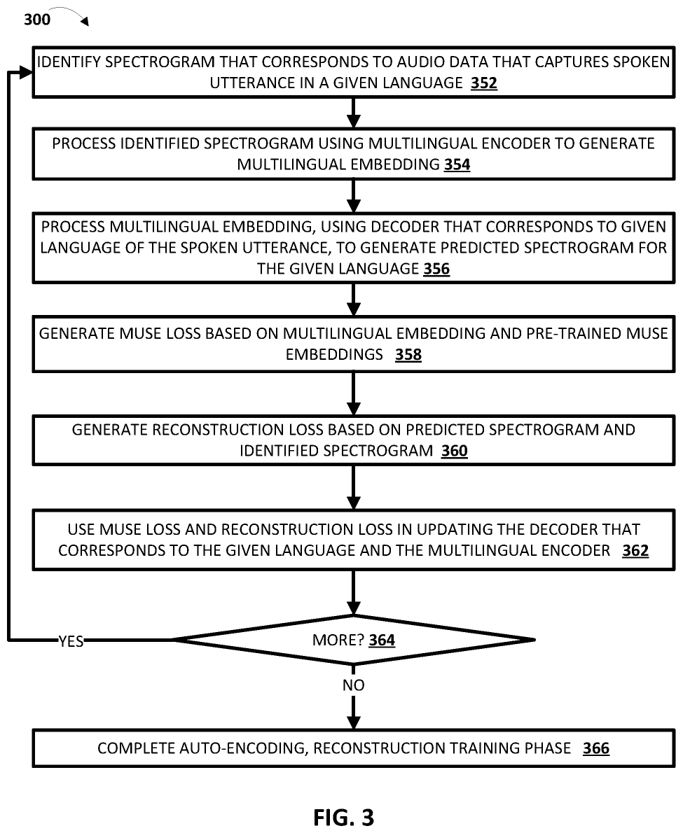

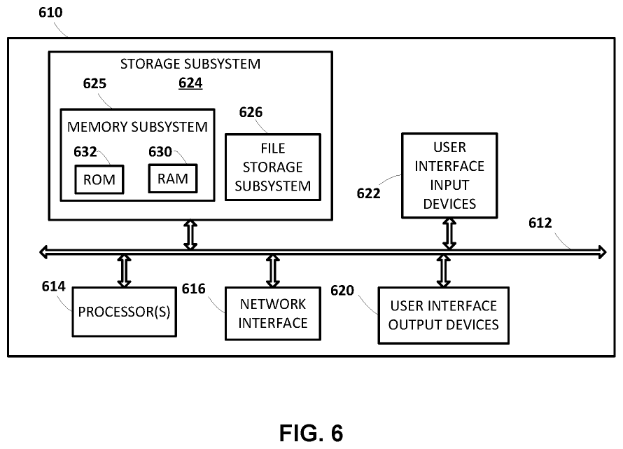

Turning now to FIG. 3, a flowchart is depicted that illustrates an example method 300 of training a multilingual encoder and decoders using monolingual data and in an auto-encoding, reconstruction training phase. For convenience, the operations of the method 300 are described with reference to a system that performs the operations. This system of the method 300 includes one or more processors, memory, and/or other component(s) of computing device(s) (e.g., S2ST system 120 and/or training system 140 of FIG. 1, client device 610 of FIG. 6, one or more servers, and/or other computing devices). Moreover, while operations of the method 300 are shown in a particular order, this is not meant to be limiting. One or more operations may be reordered, omitted, and/or added.

At block 352, the system identifies a spectrogram that corresponds to audio data that captures a spoken utterance in a given language. For example, the system can receive the spectrogram, or can receive the audio data and generate the spectrogram based on the received audio data. The spectrogram or the audio data can be from a corpus of monolingual data. The monolingual data of the corpus can include instances of data from a first language, instances of data from a second language, etc. However, each instance is monolingual, as opposed to bilingual, in that each instance is not paired with corresponding data in an alternative language. For example, the monolingual data can include a spectrogram based on audio data capturing an utterance of a user in a first language, and it is not paired with any corresponding utterance in a second language.

It is noted that in some iterations of block 352 the given language will be a first language and that in some other iterations of block 352 the given language will be a second language that is distinct from the first language. Further, in some implementations, in yet other iterations of block 352 the given language will be a third language that is distinct from the first and second languages.

At block 354, the system processes the spectrogram identified at block 352, using a multilingual encoder, to generate a multilingual embedding.

At block 356, the system processes the multilingual embedding generated at block 354, using a decoder that corresponds to the given language (of block 352), to generate a predicted spectrogram for the given language. For example, multiple decoders can be available, each corresponding to a different language, and the system processes the multilingual embedding, using a given one of those decoders, based on the given one of those decoders corresponding to the given language of block 352 (i.e., the language of the spoken utterance reflected by the spectrogram of block 352).

At block 358, the system generates a MUSE loss based on the multilingual embedding generated at block 354 and pre-trained MUSE embeddings. For example, in generating a MUSE loss the system can generate the MUSE loss based on the multilingual embedding and based on N corresponding pre-trained MUSE embeddings. The N corresponding pre-trained MUSE embeddings can each be for a corresponding word (or other token) of a transcript of the spoken utterance, and can be selected based on the transcript of the spoken utterance of block 352.

At block 360, the system generates a reconstruction loss based on the predicted spectrogram generated at block 356 and the spectrogram identified at block 352. For example, in generating a reconstruction loss the system can generate the reconstruction loss based on comparing features of the predicted spectrogram generated at block 356 and the spectrogram identified at block 352. In some implementations, the reconstruction loss can be based on (e.g., a linear sum of) a spectrogram loss, a phoneme loss, and/or a duration loss described herein.

At block 362, the system uses the MUSE loss of block 358 and the reconstruction loss of block 360 in updating the decoder that corresponds to the given language and in updating the multilingual encoder. For example, backpropagation and/or other techniques can be utilized to update the decoder and/or the multilingual encoder based on the losses. In some implementations, batch techniques can be utilized such that updates are based on multiple MUSE losses generated through multiple iterations of block 358 and/or multiple reconstruction losses through multiple iterations of block 360.

At block 364, the system determines whether to perform more auto-encoding, reconstruction training. If so, the system proceeds back to block 352 and identifies an unprocessed spectrogram. Blocks 354, 356, 358, 360, and 362 can then be performed based on the unprocessed spectrogram. If not, the system proceeds to block 366. In some implementations, at block 364 the system determines whether to perform more auto-encoding, reconstruction training based on one or more criteria such as whether any unprocessed spectrograms remain, whether a threshold quantity of training iterations have been performed, whether a threshold duration of training has expired, and/or other criterion/criteria.

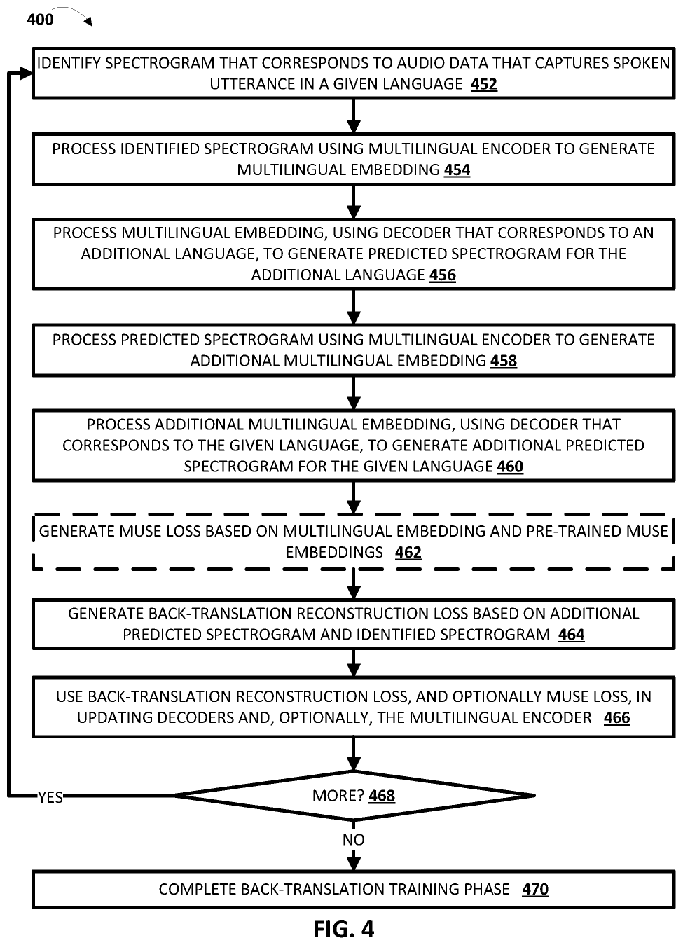

At block 366, the system completes the auto-encoding, reconstruction training phase. In some implementations, the system can then proceed to perform method 400 of FIG. 4.

Turning now to FIG. 4, a flowchart is depicted that illustrates an example method 400 of training a multilingual encoder and decoders using monolingual data and in a back-translation training phase. This system of the method 400 includes one or more processors, memory, and/or other component(s) of computing device(s) (e.g., S2ST system 120 and/or training system 140 of FIG. 1, client device 610 of FIG. 6, one or more servers, and/or other computing devices). Moreover, while operations of the method 400 are shown in a particular order, this is not meant to be limiting. One or more operations may be reordered, omitted, and/or added.

At block 452, the system identifies a spectrogram that corresponds to audio data that captures a spoken utterance in a given language. For example, the system can receive the spectrogram, or can receive the audio data and generate the spectrogram based on the received audio data. The spectrogram or the audio data can be from a corpus of monolingual data.

It is noted that in some iterations of block 452 the given language will be a first language and that in some other iterations of block 452 the given language will be a second language that is distinct from the first language. Further, in some implementations, in yet other iterations of block 452 the given language will be a third language that is distinct from the first and second languages.

At block 454, the system processes the spectrogram identified at block 452, using a multilingual encoder, to generate a multilingual embedding.

At block 456, the system processes the multilingual embedding generated at block 454, using a decoder that corresponds to an additional language, that differs from the given language of block 452, to generate a predicted spectrogram for the additional language. For example, multiple decoders can be available, each corresponding to a different language, and the system processes the multilingual embedding, using a given one of those decoders, based on the given one of those decoders corresponding to a language that differs from the given language of block 452 (i.e., the language of the spoken utterance reflected by the spectrogram of block 452).

At block 458, the system processes the predicted spectrogram, of block 456, using the multilingual encoder to generate an additional multilingual embedding.

At block 460, the system processes the additional multilingual embedding, of block 458, using a decoder that corresponds to the given language to generate an additional predicted spectrogram for the given language. For example, multiple decoders can be available, each corresponding to a different language, and the system processes the additional multilingual embedding, using a given one of those decoders, based on the given one of those decoders corresponding to the given language of block 452 (i.e., the language of the spoken utterance reflected by the spectrogram of block 452).

At optional block 462, the system generates a MUSE loss based on the multilingual embedding generated at block 454 and pre-trained MUSE embeddings. For example, in generating a MUSE loss the system can generate the MUSE loss based on the multilingual embedding and based on N corresponding pre-trained MUSE embeddings.

At block 464, the system generates a back-translation reconstruction loss based on the additional predicted spectrogram generated at block 460 and the spectrogram identified at block 452. For example, in generating a back-translation reconstruction loss the system can generate the reconstruction loss based on comparing features of the additional predicted spectrogram generated at block 460 and the spectrogram identified at block 452. In some implementations, the back-translation reconstruction loss can be based on (e.g., a linear sum of) a spectrogram loss, a phoneme loss, and/or a duration loss described herein.

At block 466, the system uses the back-translation reconstruction loss of block 464, and optionally the MUSE loss of block 462, in updating the decoders and, optionally, the multilingual encoder. For example, the system can use the MUSE loss to update the multilingual encoder and the back-translation reconstruction loss to update the decoders. For instance, backpropagation and/or other techniques can be utilized to update the decoder and/or the multilingual encoder based on the losses. In some implementations, batch techniques can be utilized such that updates are based on multiple back-translation reconstruction losses through multiple iterations of block 464 and/or multiple MUSE losses generated through multiple iterations of block 462.

At block 468, the system determines whether to perform more back-translation training. If so, the system proceeds back to block 452 and identifies an unprocessed spectrogram. Blocks 454, 456, 458, 460, 462, 464, and 466 can then be performed based on the unprocessed spectrogram. If not, the system proceeds to block 470. In some implementations, at block 464 the system determines whether to perform more back-translation training based on one or more criteria such as whether any unprocessed spectrograms remain, whether a threshold quantity of training iterations have been performed, whether a threshold duration of training has expired, and/or other criterion/criteria.

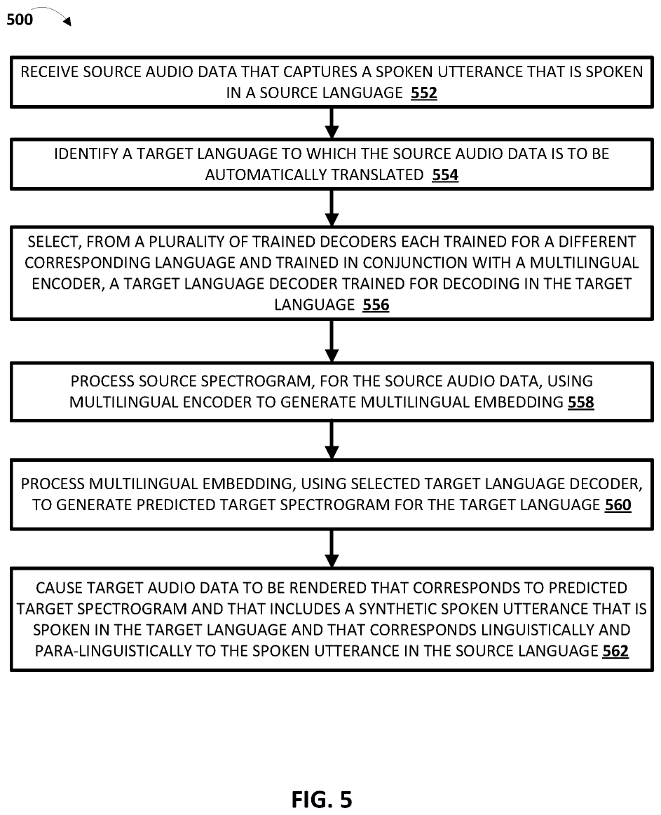

At block 470, the system completes the back-translation training. In some implementations, the system can then provide the trained multilingual encoder and trained decoder(s) for use and/or can use the trained multilingual encoder and trained decoder(s). In providing them for use, the system can transmit the trained multilingual encoder and trained decoder(s) to one or more client devices (optionally as part of an application) and/or make them accessible to one or more computing devices via an application programming interface (API). Using the trained multilingual encoder and trained decoder(s) can optionally include one or more steps of method 500 of FIG. 5.

Turning now to FIG. 5, a flowchart is depicted that illustrates an example method 500 of utilizing a trained multilingual encoder and one of a plurality of trained decoders. For convenience, the operations of the method 500 are described with reference to a system that performs the operations. This system of the method 500 includes one or more processors, memory, and/or other component(s) of computing device(s) (e.g., client device 110 and/or S2ST system 120 of FIG. 1, client device 610 of FIG. 6, one or more servers, and/or other computing devices). Moreover, while operations of the method 500 are shown in a particular order, this is not meant to be limiting. One or more operations may be reordered, omitted, and/or added.

At block 552, the system receives source audio data that captures a spoken utterance that is spoken in a source language. The audio data can, for example, be detected via microphone(s) of a client device. It is noted that in some iterations of block 552 the source language will be a first language and that in some other iterations of block 552 the source language will be a second language that is distinct from the first language. Further, in some implementations, in yet other iterations of block 552 the source language will be a third language that is distinct from the first and second languages.

At block 554, the system identifies a target language to which the source audio data is to be automatically translated. In some implementations, the system can identify the target language based on it being specified in user interface input provided at an input device of a client device via which the source audio data is received at block 552. For example, the target language can be specified in touch input (e.g., selected from a list of candidate target languages) or specified in spoken input. In some other implementations, the system can identify the target language automatically and independently of any user interface input. It is noted that different target languages can be identified at different iterations of block 554.

At block 556, the system selects, from a plurality of trained decoders each trained for a different corresponding language and trained in conjunction with a multilingual encoder, a target language decoder trained for decoding in the target language. Put another way, the system selects the target language decoder because it is trained for decoding in the target language and because the target language is the one identified at block 554.

At block 558, the system processes a source spectrogram, for the source audio data received at block 552, using a multilingual encoder, to generate a multilingual embedding.

At block 560, the system processes the multilingual embedding generated at block 558, using the target language decoder selected at block 556, to generate a predicted spectrogram for the target language.

At block 562, the system causes audio data to be rendered that corresponds to the predicted target spectrogram of block 560. The target audio data, as a result of the predicted target spectrogram, includes a synthetic spoken utterance that is spoken in the target language and that corresponds linguistically and para-linguistically to the spoken utterance in the source language. The system can cause the audio data to be rendered at a client device via which source audio data is received at block 552 and/or at a separate client device, such as one that is in a communications session with the client device via which source audio data is received at block 552.

Turning now to FIG. 6, a block diagram of an example computing device 610 that may optionally be utilized to perform one or more aspects of techniques described herein is depicted. In some implementations, one or more of a client device, S2ST component(s), training system component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes identifying a first language spectrogram that corresponds to ground truth first language audio data that captures a first language utterance that is spoken in a first language. The method further includes processing the first language spectrogram, using a multilingual encoder, to generate a multilingual embedding. The method further includes processing the multilingual embedding, using a second language decoder, to generate a predicted second language spectrogram. The method further includes processing the predicted second language spectrogram, using the multilingual encoder, to generate an additional multilingual embedding. The method further includes processing the additional multilingual embedding, using a first language decoder, to generate a predicted first language spectrogram. The method further includes generating a back-translation loss based on comparing the predicted first language spectrogram to the first language spectrogram. The method further includes updating the first language decoder and the second language decoder based on the back-translation loss.

These and other implementations of the technology disclosed herein can optionally include one or more of the following features.

In some implementations, the method further includes: identifying a second language spectrogram that corresponds to ground truth second language audio data that captures a second language utterance that is spoken in a second language; processing the second language spectrogram, using the multilingual encoder, to generate a further multilingual embedding; processing the further multilingual embedding, using the first language decoder, to generate an additional predicted first language spectrogram; processing the additional predicted first language spectrogram, using the multilingual encoder, to generate a further additional multilingual embedding; and processing the further additional multilingual embedding, using the second language decoder, to generate an additional predicted second language spectrogram. In those implementations, generating the back-translation loss, or generating an additional back-translation loss, is further based on comparing the additional predicted second language spectrogram to the second language spectrogram. In some versions of those implementations, generating the back-translation loss includes: generating a first-to-second language back-translation loss based on comparing the predicted first language spectrogram to the first language spectrogram; generating a second-to-first language back-translation loss based on comparing the additional predicted second language spectrogram to the second language spectrogram; and generating the back-translation loss based on a sum of the first-to-second language back-translation loss and the second-to-first language back-translation loss.

In some implementations, the method further includes updating the multilingual encoder based on the back-translation loss. In some versions of those implementations, the method further includes generating a multilingual unsupervised and supervised embeddings (MUSE) loss based on the multilingual embedding, where updating the multilingual encoder is further based on the MUSE loss.

In some implementations, the method further includes: identifying an additional instance first language spectrogram that corresponds to additional ground truth first language audio data that captures an additional first language utterance that is spoken in the first language; processing the additional instance first language spectrogram, using the multilingual encoder, to generate an additional instance multilingual embedding; processing the additional instance multilingual embedding, using a third language decoder, to generate a predicted third language spectrogram; processing the predicted third language spectrogram, using the multilingual encoder, to generate an additional instance multilingual embedding; processing the additional instance multilingual embedding, using the first language decoder, to generate an additional instance predicted first language spectrogram; generating an additional instance back-translation loss based on comparing the additional instance predicted first language spectrogram to the additional instance first language spectrogram; and further updating the first language decoder and the third language decoder based on the back-translation loss. In some versions of those implementations, the method further includes: identifying an additional instance third language spectrogram that corresponds to additional ground truth third language audio data that captures a third language utterance that is spoken in a third language; processing the third language spectrogram, using the multilingual encoder, to generate a further additional instance multilingual embedding; processing the further additional instance multilingual embedding, using the first language decoder, to generate an additional instance predicted first language spectrogram; processing the additional instance predicted first language spectrogram, using the multilingual encoder, to generate a further additional instance multilingual embedding; processing the further additional instance multilingual embedding, using the third language decoder, to generate an additional instance predicted third language spectrogram. In some of those versions, generating the additional back-translation loss, or generating a yet further back-translation loss, is further based on comparing the additional instance predicted third language spectrogram to the additional instance third language spectrogram.

In some implementations, the method further includes, prior to updating the first language decoder and the second language decoder based on the back-translation loss: training the multilingual decoder, the first language decoder, and the second language decoder during an auto-encoding, reconstruction training phase.

In some implementations, the method further includes, subsequent to updating the first language decoder and the second language decoder based on the back-translation loss, providing the multilingual encoder and at least one of the first language decoder and the second language decoder for user in speech-to-speech translation.

In some implementations, the method further includes, subsequent to updating the first language decoder and the second language decoder based on the back-translation loss: using the multilingual encoder and the second language decoder in processing a new spectrogram, that corresponds to audio data that captures a new spoken utterance in the first language, to automatically generate a new predicted second language spectrogram that corresponds to generated audio data that includes a synthetic spoken utterance that is spoken in the second language and that corresponds, both linguistically and para-linguistically, to the new spoken utterance in the first language. In some versions of those implementations, the method further includes causing the generated audio data to be rendered via one or more speakers of a client device. In some of those versions, using the multilingual encoder and the second language decoder in processing the new spectrogram to automatically generate the new predicted second language spectrogram includes processing the new spectrogram, using the multilingual encoder, to generate a new multilingual embedding and processing new multilingual embedding, using the second language decoder, to generate the new predicted second language spectrogram. In some of those versions, the method further includes determining that the new spoken utterance is to be automatically translated to the second language and, in response to determining that the new spoken utterance is to be automatically translated to the second language: selecting the second language decoder, from multiple candidate language decoders including the second language decoder and the first language decoder and using the selected second language decoder in processing the new multilingual embedding.

In some implementations, a method implemented by processor(s) is provided and includes receiving source audio data that captures a spoken utterance that is spoken in a source language. The method further includes identifying a target language to which the source audio data is to be automatically translated. The method further includes selecting, from a plurality of trained decoders each trained for a different corresponding language and each trained in conjunction with a multilingual encoder, a target language decoder. Selecting the target language decoder is based on identifying the target language for which target audio data is to be automatically translated, and is based on the target language decoder being trained for decoding in the target language. The method further includes processing a source spectrogram of the source audio data using the multilingual encoder to generate a multilingual embedding of the source audio data. The multilingual encoder is one previously trained based on spoken utterances in a plurality of languages, including the source language, and the multilingual embedding is in a multilingual embedding space. The method further includes processing the multilingual embedding of the source audio data, using the selected target language decoder, to generate a target spectrogram. The method further includes causing target audio data to be rendered that corresponds to the target spectrogram. The target audio data includes a synthetic spoken utterance that is spoken in the target language and that corresponds, both linguistically and para-linguistically, to the spoken utterance in the source language.

These and other implementations of the technology disclosed herein can optionally include one or more of the following features.

In some implementations, the plurality of trained decoders include the target language decoder and a source language decoder, the source language decoder being trained for decoding in the source language.

In some implementations, identifying the target language includes identifying the target language based on the target language being specified in user interface input provided via an input device. In some of those implementations, the user interface input is touch input that is directed to a graphical element that corresponds to the target language.

In some implementations, the source audio data is captured via one or more microphones of a client device and causing the target audio data to be rendered comprises causing the target audio data to be rendered via one or more speakers of the client device.

In some implementations, the plurality of trained decoders include the target language decoder and a source language decoder, the source language decoder being trained for decoding in the source language.

In some implementations, the multilingual encoder is trained using a multilingual unsupervised and supervised embeddings (MUSE) loss and/or using a reconstruction loss that is based on back-translation.

In some implementations, the target language decoder is trained using a reconstruction loss between source speech and back-translated speech. The back-translated speech is generated by processing predicted target language speech using the multilingual encoder and a source language decoder trained for decoding in the source language. The predicted target language speech is generated by processing the source language speech using the multilingual encoder and the target language decoder.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
identifying a first language spectrogram that corresponds to ground truth first language audio data that captures a first language utterance that is spoken in a first language;
processing the first language spectrogram, using a multilingual encoder, to generate a multilingual embedding;
processing the multilingual embedding, using a second language decoder, to generate a predicted second language spectrogram;
processing the predicted second language spectrogram, using the multilingual encoder, to generate an additional multilingual embedding;
processing the additional multilingual embedding, using a first language decoder, to generate a predicted first language spectrogram;
generating a back-translation loss based on comparing the predicted first language spectrogram to the first language spectrogram; and
updating the first language decoder and the second language decoder based on the back-translation loss.

2. The method of claim 1, further comprising:
identifying a second language spectrogram that corresponds to ground truth second language audio data that captures a second language utterance that is spoken in a second language;
processing the second language spectrogram, using the multilingual encoder, to generate a further multilingual embedding;
processing the further multilingual embedding, using the first language decoder, to generate an additional predicted first language spectrogram;
processing the additional predicted first language spectrogram, using the multilingual encoder, to generate a further additional multilingual embedding;
processing the further additional multilingual embedding, using the second language decoder, to generate an additional predicted second language spectrogram;
wherein generating the back-translation loss is further based on comparing the additional predicted second language spectrogram to the second language spectrogram.

3. The method of claim 2, wherein the generating the back-translation loss comprises:
generating a first-to-second language back-translation loss based on comparing the predicted first language spectrogram to the first language spectrogram;
generating a second-to-first language back-translation loss based on comparing the additional predicted second language spectrogram to the second language spectrogram; and
generating the back-translation loss based on a sum of the first-to-second language back-translation loss and the second-to-first language back-translation loss.

4. The method of claim 1, further comprising updating the multilingual encoder based on the back-translation loss.

5. The method of claim 4, further comprising:
generating a multilingual unsupervised and supervised embeddings (MUSE) loss based on the multilingual embedding;
wherein updating the multilingual encoder is further based on the MUSE loss.

6. The method of claim 1, further comprising:
prior to updating the first language decoder and the second language decoder based on the back-translation loss:
training the multilingual decoder, the first language decoder, and the second language decoder during an auto-encoding, reconstruction training phase.

7. The method of claim 1, further comprising:
identifying an additional instance first language spectrogram that corresponds to additional ground truth first language audio data that captures an additional first language utterance that is spoken in the first language;
processing the additional instance first language spectrogram, using the multilingual encoder, to generate an additional instance multilingual embedding;
processing the additional instance multilingual embedding, using a third language decoder, to generate a predicted third language spectrogram;
processing the predicted third language spectrogram, using the multilingual encoder, to generate an additional instance multilingual embedding;
processing the additional instance multilingual embedding, using the first language decoder, to generate an additional instance predicted first language spectrogram;
generating an additional instance back-translation loss based on comparing the additional instance predicted first language spectrogram to the additional instance first language spectrogram; and
further updating the first language decoder and the third language decoder based on the back-translation loss.

8. The method of claim 7, further comprising:
identifying an additional instance third language spectrogram that corresponds to additional ground truth third language audio data that captures a third language utterance that is spoken in a third language;
processing the third language spectrogram, using the multilingual encoder, to generate a further additional instance multilingual embedding;
processing the further additional instance multilingual embedding, using the first language decoder, to generate an additional instance predicted first language spectrogram;
processing the additional instance predicted first language spectrogram, using the multilingual encoder, to generate a further additional instance multilingual embedding;
processing the further additional instance multilingual embedding, using the third language decoder, to generate an additional instance predicted third language spectrogram;
wherein generating the additional back-translation loss is further based on comparing the additional instance predicted third language spectrogram to the additional instance third language spectrogram.

9. The method of claim 1, further comprising:
subsequent to updating the first language decoder and the second language decoder based on the back-translation loss:
using the multilingual encoder and the second language decoder in processing a new spectrogram, that corresponds to audio data that captures a new spoken utterance in the first language, to automatically generate a new predicted second language spectrogram that corresponds to generated audio data that includes a synthetic spoken utterance that is spoken in the second language and that corresponds, both linguistically and para-linguistically, to the new spoken utterance in the first language.

10. The method of claim 9, further comprising causing the generated audio data to be rendered via one or more speakers of a client device.

11. The method of claim 9, wherein using the multilingual encoder and the second language decoder in processing the new spectrogram to automatically generate the new predicted second language spectrogram comprises:
processing the new spectrogram, using the multilingual encoder, to generate a new multilingual embedding; and
processing new multilingual embedding, using the second language decoder, to generate the new predicted second language spectrogram.

12. The method of claim 11, further comprising:
determining that the new spoken utterance is to be automatically translated to the second language;
in response to determining that the new spoken utterance is to be automatically translated to the second language:
selecting the second language decoder, from multiple candidate language decoders including the second language decoder and the first language decoder, and
using the selected second language decoder in processing the new multilingual embedding.

13. A method implemented by one or more processors, the method comprising:
receiving source audio data that captures a spoken utterance that is spoken in a source language;
identifying a target language to which the source audio data is to be automatically translated;
selecting, from a plurality of trained decoders each trained for a different corresponding language and each trained in conjunction with a multilingual encoder, a target language decoder,
wherein selecting the target language decoder is based on the identifying the target language for which target audio data is to be automatically translated, and is based on the target language decoder being trained for decoding in the target language;
processing a source spectrogram of the source audio data using the multilingual encoder to generate a multilingual embedding of the source audio data, the multilingual encoder being trained based on spoken utterances in a plurality of languages, including the source language, and the multilingual embedding being in a multilingual embedding space;
processing the multilingual embedding of the source audio data, using the selected target language decoder, to generate a target spectrogram;
causing target audio data to be rendered that corresponds to the target spectrogram, wherein the target audio data includes a synthetic spoken utterance that is spoken in the target language and that corresponds, both linguistically and para-linguistically, to the spoken utterance in the source language.

14. The method of claim 13, wherein the plurality of trained decoders include the target language decoder and a source language decoder, the source language decoder being trained for decoding in the source language.

15. The method of claim 13, wherein identifying the target language comprises identifying the target language based on the target language being specified in user interface input provided via an input device.

16. The method of claim 15, wherein the user interface input is touch input that is directed to a graphical element that corresponds to the target language.

17. The method of claim 13, wherein the source audio data is captured via one or more microphones of a client device, and wherein causing the target audio data to be rendered comprises causing the target audio data to be rendered via one or more speakers of the client device.

18. The method of claim 13, wherein the plurality of trained decoders include the target language decoder and a source language decoder, the source language decoder being trained for decoding in the source language.

19. The method of claim 13, wherein the multilingual encoder is trained using a multilingual unsupervised and supervised embeddings (MUSE) loss and/or using a reconstruction loss that is based on back-translation.

20. The method of claim 13, wherein the target language decoder is trained using a reconstruction loss between source speech and back-translated speech,
wherein the back-translated speech is generated by processing predicted target language speech using the multilingual encoder and a source language decoder trained for decoding in the source language, and
wherein the predicted target language speech is generated by processing the source language speech using the multilingual encoder and the target language decoder.
